(19) United States
(12) Patent Application Publication
(10) Pub. No.: US 2013/0160132 A1
(43) Pub. Date: Jun. 20, 2013

(54) CROSS-SITE REQUEST FORGERY PROTECTION

(71) Applicants: POLINA GENOVA, VELIKO TARNOVO (BG); MICHAEL ENGLER, WALLDORF (DE); SLAVOMIR GRIGOROV, SOFIA (BG); MARIA JUROVA, SOFIA (BG); BOJIDAR KADREV, SOFIA (BG); MARTIN SCHMID, MUENCHINGEN (DE); TSVETKO TRENDAFILOV, VRATSA (BG); DIYAN YORDANOV, VARNA (BG); IWAN ZAREMBO, REILINGEN (DE)

(72) Inventors: POLINA GENOVA, VELIKO TARNOVO (BG); MICHAEL ENGLER, WALLDORF (DE); SLAVOMIR GRIGOROV, SOFIA (BG); MARIA JUROVA, SOFIA (BG); BOJIDAR KADREV, SOFIA (BG); MARTIN SCHMID, MUENCHINGEN (DE); TSVETKO TRENDAFILOV, VRATSA (BG); DIYAN YORDANOV, VARNA (BG); IWAN ZAREMBO, REILINGEN (DE)

(21) Appl. No.: 13/325,111

(22) Filed: Dec. 14, 2011

(51) Int. Cl. G06F 21/24

(52) U.S. Cl. 726/26

(57) ABSTRACT

Various embodiments of systems and methods for Cross-Site Request Forgery (XSRF) protection are described herein. An XSRF protection framework provides rich configuration possibilities for protection using an XSRF token. In one aspect—XSRF encoding is performed for a set of URLs according to a configuration and then a token validation is performed for incoming requests to protected resources. In another aspect—XSRF token leakage via the referrer header to external URLs is prevented.

### FIELD

The field relates to protection from malicious attacks of a web site. More precisely, the field relates to Cross-Site Request Forgery (CSRF/XSRF) protection.

### BACKGROUND

Cross-Site Request Forgery (CSRF/XSRF) is one of the most common types of malicious attacks of a web site. Nearly every web application framework is vulnerable to XSRF attacks.

In its essence, Cross-Site Request Forgery (CSRF/XSRF) is an attack that tricks a victim's browser to send a request to vulnerable web application, which then performs an undesired action such as change credentials, purchase something, or perform an on-line financial operation on behalf of the victim. This vulnerability is extremely widespread, as most of the web applications rely solely on automatically submitted credentials such as session cookies, basic authenticated credentials, source Internet Protocol (IP) addresses, Secure Socket Layer (SSL) certificates or Windows domain credentials. Therefore, because the user is authenticated to the site, the site will have no way to distinguish the XSRF attack from a legitimate user request. XSRF attacks generally target functions that cause a state change on the server or other critical or resource consuming operations. The attack is called “cross-site” as the malicious code is not necessarily on the attacked site.

XSRF attacks cannot always be prevented by the web user. They may have to be addressed inside web applications. Applications may ensure that for critical operations they are not relying only on credentials or tokens that are automatically submitted by browsers.

### SUMMARY

Various embodiments of systems and methods for XSRF protection are described herein. In one embodiment, the method includes receiving a configuration for an XSRF protection framework at a server computer, the XSRF protection framework used by one or more web applications residing at the server computer. The method also includes encoding an XSRF token valid for a lifecycle of a user session by adding a secure identifier to uniform resource locators (URLs) of the web applications residing at the server computer and validating the XSRF token when processing a request to a protected URL in the user session.

In other embodiments, the system includes a server computer having a processor for executing program code and memory in communication with the processor. The system also includes a configurator module to configure an XSRF protection framework at the server computer, the XSRF protection framework used by one or more web applications residing at the server computer. The system further includes an encoder module to encode an XSRF token valid for a lifecycle of a user session by adding a secure identifier to uniform resource locators (URLs) of the one or more web applications residing at the server computer. The system further includes a validator module to validate the XSRF token, when processing a request to a protected URL in the user session.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a sequence diagram representing a use case for an XSRF attack, according to one embodiment.

FIG. 2 is a flow diagram of an embodiment of a method for implementing XSRF protection.

FIG. 3 is a block diagram of an embodiment of a system for implementing XSRF protection.

FIG. 4 is a block diagram illustrating a computing environment in which the techniques described for XSRF protection can be implemented, according to an embodiment.

### DETAILED DESCRIPTION

Embodiments of techniques for XSRF protection are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

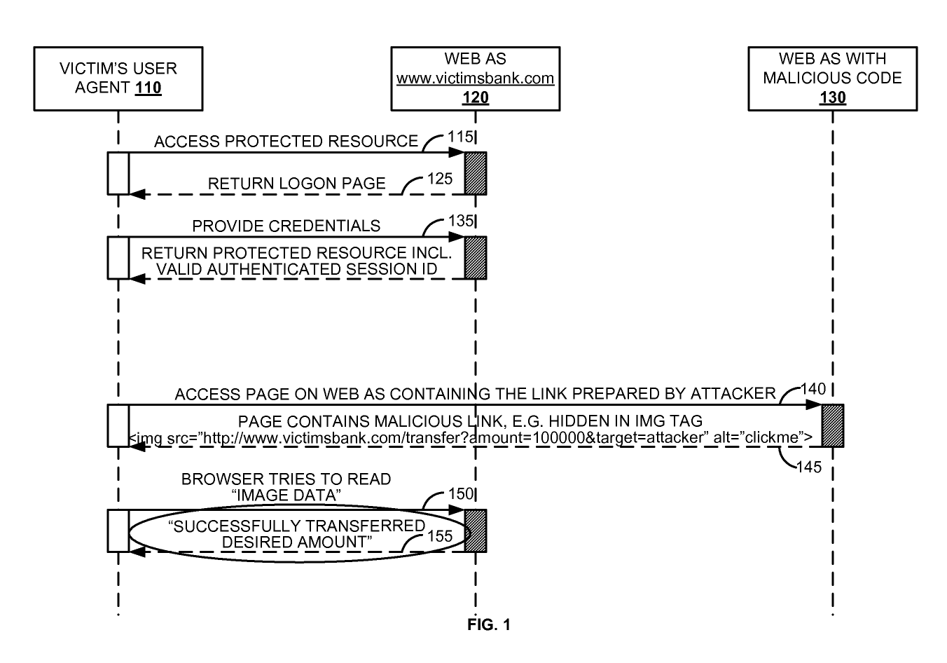

FIG. 1 represents a sequence diagram representing a typical use case for an XSRF attack, according to one embodiment. The victim 110 requests access to a protected resource 120 via a request 115. The protected resource may be the online banking capabilities of the victim's personal bank such as a web application server (AS) “www.VictimsBank.com”. The victim 110 may trigger the request to the protected resource 120, for example, to execute a financial operation. The protected resource 120 returns a logon page 125 in response to the request 115. Then the victim 110 enters credentials via request 135 and obtains a valid authenticated session in response 140. In case a Single Sign-On (SSO) mechanism is in place, no user interaction is required for providing credentials. The victim 110 may then be tricked by a hacker to access a web page with malicious code via a request 140. For example, the victim is misled to click at a link within the same browser session that the victim is logged in. The link may be provided, for example, through a forum, e-mail, etc. The attacker makes the victim's browser to issue unwanted request 150, which is hidden and sent to the vulnerable site 120 without the victim's consent. The unwanted request 150 is then confirmed by a response 155. An XSRF protection token mechanism may protect an application against a similar attack. An additional parameter, such as an XSRF token, may be used to protect critical requests. According to one embodiment, an XSRF token is a unique secure identifier generated after authentication and bound to a user session. Access to a critical web page is given not only on the basis of cookies, but also on request parameters including XSRF token, which guarantees that the request cannot be automatically injected with the XSRF token. The XSRF token is created after the user login so a hacker cannot generate it in advance. If the token is missing or different to the one known to the user session, the request is going to be rejected.

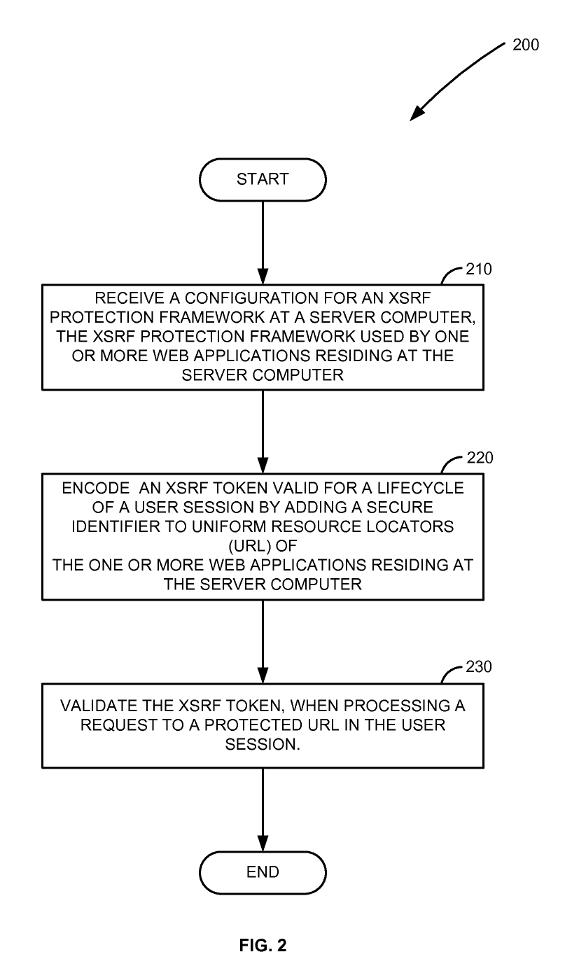

FIG. 2 is a flow diagram of an embodiment of a method 200 for implementing XSRF protection. The method begins at block 210 with receiving a configuration for an XSRF protection framework at a server computer. The XSRF protection framework is used by one or more web applications residing at the server computer. In one embodiment, the configuration of the XSRF protection framework includes a set of predefined protected uniform resource locators (URLs). The predefined URLs are web addresses that require protection. The protected URLs are subject to XSRF protection. An application that needs to use the XSRF protection framework should first define all its critical and security sensitive URLs. Criteria for such URLs may be, for example, URLs that trigger state changing actions, URLs that trigger other sensitive operations, POST actions/requests, URLs that reveal any sort of confidential information, etc. In some embodiments, the set of protected URLs may not be exact URLs but the set may be pattern based. For instance, URLs matching a predefined pattern are protected.

In some embodiments, the configuration of the XSRF protection framework includes defining a Hypertext Transfer Protocol (HTTP) method for the set of protected URLs. For example, URLs can be protected for POST HTTP requests only and no protection for GET requests.

In one embodiment, part of the configuration of the XSRF protection framework may be a rule to exclude the XSRF protection for some URLs. Such URLs may be, for example, URLs to images and other supplementary data that need not be protected.

Turning back to FIG. 2, at block 220, an XSRF token valid for a lifecycle of a user session is encoded. The encoding is performed by adding a secure identifier to URLs of the web applications residing at the server computer. Thus, URLs that are preconfigured as protected URLs are encoded with an XSRF token. The encoding may be performed either by the XSRF protection framework or a web application. In one embodiment, the XSRF protection framework performs generation of the XSRF token, mapping the XSRF token to the user session, and the encoding by adding the XSRF token to the URLs of web applications. In some embodiments, applications add themselves the XSRF token to their URLs but the XSRF token is provided by the XSRF protection framework.

In one embodiment, an XSRF token is added to a POST action as POST parameter through a hidden field element. Such encoding is referred to as POST-based encoding. This method generates a hidden field containing the XSRF token to be included in the form element of the response.

In another embodiment, an XSRF token is added to a GET based link as an URL parameter (e.g. http://<host>:<port>/<app_url>?xsrfid_name=xsrfid_value). This kind of encoding is referred to as GET-based encoding. The Get-based encoding modifies the URL to be protected by enhancing it with an XSRF token as a request parameter.

Turning back to FIG. 2, at block 230, the XSRF token is validated when processing a request to access a protected URL in the user session. In one embodiment, the validation is performed by the server. Such validation is also referred to as server managed validation. The server managed validation is at hand when the validation of incoming requests is performed by the XSRF protection framework before the requests reach web applications. In other embodiments, the validation of incoming requests is performed by the respective web application. This type of validation is referred to as application-managed validation. In case of application-managed validation, the valid token is provided by the XSRF protection framework.

In one embodiment, in case of POST-based encoding, the validation of incoming requests to the respective URL is performed by an application-managed validation. The validation includes parsing a multipart POST body and extracting the XSRF token from it. Then the extracted XSRF token is compared to the one that is correct for the current user session. In case of an invalid token, an appropriate error handling may be ensured.

In one embodiment, in case of GET-based encoding, the validation of incoming requests is performed by server-managed validation. In this embodiment, the request will be validated prior to reaching an application. In case the XSRF token is equal to the one associated with the user session, the request reaches the application. Otherwise an error page indicating a possible XSRF attack may be triggered.

Requests to external servers contain a caller URL in the “referrer header” field of the HTTP request. A resource protected via GET-based encoding will have an XSRF token in the URL. Therefore, if the request is to an external server, it's XSRF token is visible to this external server. To avoid such leakage, all requests sent from GET-based resources to external systems must be processed to remove the XSRF token. In some embodiments, for preventing an XSRF token leakage through the referrer header field of a request to external URLs, the XSRF protection framework is configured to include a rule to catch such requests to external URLs and remove the XSRF token before the request is sent. This is a typical situation when handling HTML links to embedded resources located on external servers. For example, these resources may be images, Cascading Style Sheets (CSS) files, and java script (JS) files that are loaded and embedded in the current page automatically by browsers.

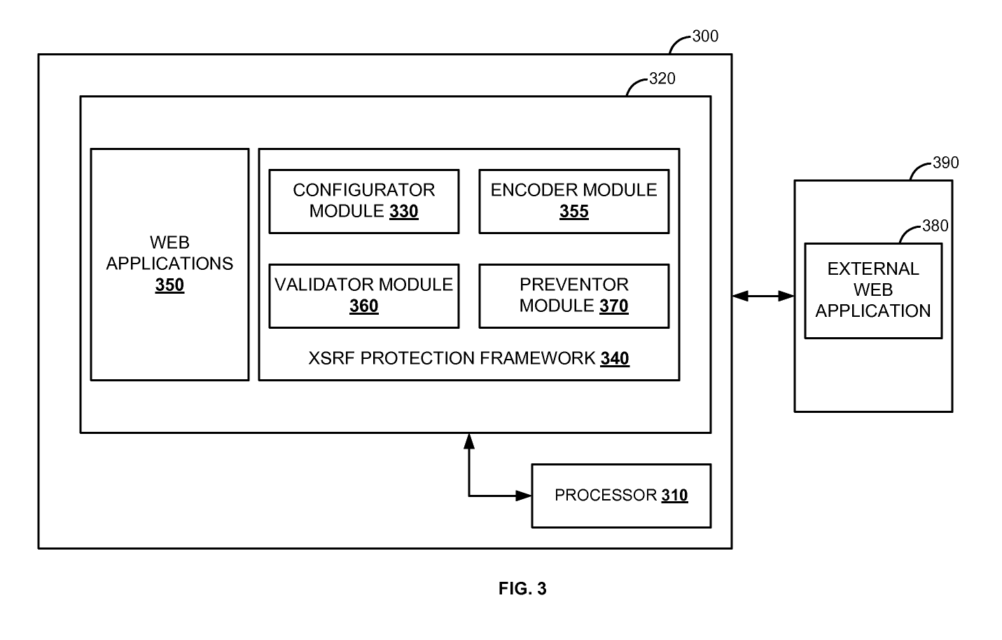

FIG. 3 is a block diagram of an embodiment of a system for XSRF protection. The system includes a server computer 300 with a processor 310 for executing program code. Computer memory 320 is in communication with the processor 310. The system 300 further includes a configurator module 330 within the memory 320, the configurator module 330 to configure an XSRF protection framework 340 at the server computer. The XSRF protection framework 340 is intended to be used by the web applications 350. The web applications 350 reside at the server computer 300. In one embodiment, the configurator module 330 is operable to predefine a set of protected URLs and define an HTTP method for the set of protected URLs. The predefined URLs are web addresses that require protection. The protected URLs are subject to XSRF protection. An application from web applications 350 that needs to use the XSRF protection framework 340 should first define all its critical and security sensitive URLs. Criteria for such URLs may be, for example, URLs that trigger state changing actions, URLs that trigger other sensitive operations, POST actions/requests, URLs that reveal any sort of confidential information, etc. In some embodiments, the set of protected URLs may not be exact URLs but the set may be pattern based. For instance, URLs matching a predefined pattern are protected. In another embodiment, the configurator module is operable to configure a rule to exclude the XSRF protection for a set of unprotected URLs.

The memory 320 also includes an encoder module 355. The encoder module 355 is operable to encode an XSRF token valid for a lifecycle of a user session by adding a secure identifier to uniform resource locators (URLs) of the one or more web applications 350 residing at the server computer 300.

A validator module 360, within the memory 320, is operable to validate the XSRF token, when processing a request to a protected URL in the user session. In one embodiment, the validator module 360 is operable to validate the XSRF token based on a server based validation. In another embodiment, the validator module is operable to validate the XSRF token based on an application based validation.

In some embodiments, a preventor module 370, which is also within the memory 320, is operable to configure a rule to prevent an XSRF token leakage through a referrer header field of a request, when processing the request to external URLs. The external URL may be link to an external web application 380, residing at an external web application server 390.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

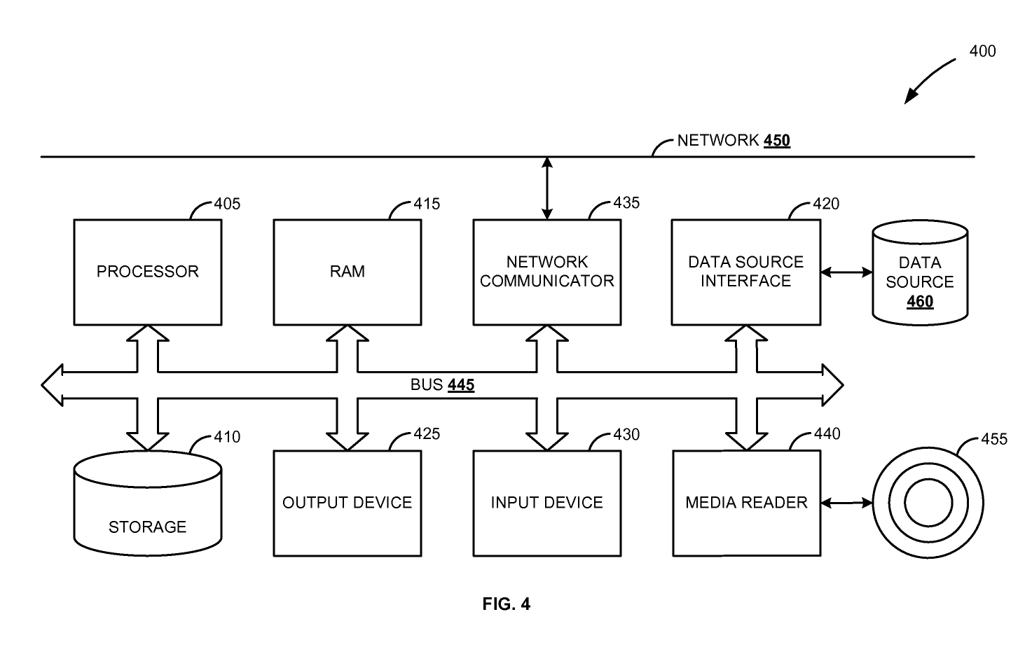

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method for Cross-Site Request Forgery (XSRF) protection, comprising:
receiving a configuration for an XSRF protection framework at a server computer, the XSRF protection framework used by one or more web applications residing at the server computer;
encoding an XSRF token valid for a lifecycle of a user session by adding a secure identifier to uniform resource locators (URLs) of the one or more web applications residing at the server computer; and
validating the XSRF token, when processing a request to a protected URL in the user session.

2. The method of claim 1, wherein the configuration comprises a set of protected uniform resource locators (URLs).

3. The method of claim 2, wherein the configuration comprises defining a Hypertext Transfer Protocol (HTTP) method for the set of protected URLs.

4. The method of claim 1, wherein the configuration comprises a rule to exclude the XSRF protection for a set of unprotected URLs.

5. The method of claim 1, wherein the configuration comprises a rule to prevent an XSRF token leakage through a referrer header field of the request, while processing the request to external URLs.

6. The method of claim 1, wherein validating the XSRF token is performed based on a server managed validation.

7. The method of claim 1, wherein validating the XSRF token is performed based on an application managed validation.

8. A computer system for Cross-Site Request Forgery (XSRF) protection comprising:
a server computer having a processor; and
a memory in communication with the processor, the memory storing instructions related to:
a configurator module to configure an XSRF protection framework at the server computer, the XSRF protection framework used by one or more web applications residing at the server computer;
an encoder module to encode an XSRF token valid for a lifecycle of a user session by adding a secure identifier to uniform resource locators (URLs) of the one or more web applications residing at the server computer; and
a validator module to validate the XSRF token, when processing a request to a protected URL in the user session.

9. The system of claim 8 wherein the configurator module is further operable to:
predefine a set of protected URLs; and
define an HTTP method for the set of protected URLs.

10. The system of claim 8, wherein the configurator module is further operable to configure a rule to exclude the XSRF protection for a set of unprotected URLs.

11. The system of claim 8, further comprising a preventor module to configure a rule to prevent an XSRF token leakage through a referrer header field of the request while processing the request to external URLs.

12. The system of claim 8, wherein the validator module is further operable to validate the XSRF token based on a server based validation.

13. The system of claim 8, wherein the validator module is further operable to validate the XSRF token based on an application based validation.

14. An article of manufacture including a non-transitory computer readable storage medium to tangibly store instructions, which when executed by a computer, cause the computer to:
receive a configuration for an XSRF protection framework at a server computer, the XSRF protection framework used by one or more web applications residing at the server computer;
encode an XSRF token valid for a lifecycle of a user session by adding a secure identifier to uniform resource locators (URLs) of the one or more web applications residing at the server computer; and
validate the XSRF token, when processing a request to a protected URL in the user session.

15. The article of manufacture of claim 14, wherein the configuration comprises a set of protected URLs.

16. The article of manufacture of claim 15, wherein the configuration comprises an HTTP method for the set of protected URLs.

17. The article of manufacture of claim 14, wherein the configuration comprises a rule to exclude the XSRF protection for a set of unprotected URLs.

18. The article of manufacture of claim 14, wherein the configuration comprises a rule to prevent an XSRF token leakage through a referrer header field of the request, while processing the request to external URLs.

19. The article of manufacture of claim 14, wherein the instructions to validate the XSRF token further comprise instructions, which when executed by a computer, cause the computer to validate the token based on a server managed validation.

20. The article of manufacture of claim 14, wherein the instructions to validate the XSRF token further comprise instructions, which when executed by a computer, cause the computer to validate the token based on an application managed validation.
